(19) United States
(12) Patent Application Publication
(10) Pub. No.: US 2026/0136145 A1
(43) Pub. Date: May 14, 2026

(54) AUDIO SYSTEM AND METHOD

(71) Applicant: HARMAN PROFESSIONAL, INC., Northridge, CA (US)

(72) Inventor: Gael MARTINET, Meung-sur-Loire (FR)

(21) Appl. No.: 19/388,323

(22) Filed: Nov. 13, 2025

(30) Foreign Application Priority Data
Nov. 14, 2024 (EP) 24212863.5

(51) Int. Cl. H04R 29/00; H04R 1/24

(52) U.S. Cl. CPC H04R 29/007; H04R 1/245; H04R 2430/03

(57) ABSTRACT

A method according to the disclosure includes outputting a reference audio signal to a loudspeaker for reproduction, evaluating a first microphone signal to determine a first course of at least one parameter over a first frequency range, wherein the first microphone signal is captured by a first microphone in response to reproducing the reference audio signal by the loudspeaker, evaluating a second microphone signal to determine a second course of the at least one parameter over the first frequency range, wherein the second microphone signal is captured by a second microphone in response to reproducing the reference audio signal by the loudspeaker, blending the first course with the second course to generate at least one blended course, and outputting the at least one blended course via a communication interface.

### CROSS REFERENCE TO RELATED APPLICATIONS

This application claims priority benefit to European Patent Application Number 24212863.5 entitled “AUDIO SYSTEM AND METHOD,” filed Nov. 14, 2024, the contents of which are incorporated herein by reference in its entirety.

### BACKGROUND

### Field of the Various Embodiments

Embodiments of the subject matter disclosed herein relate to audio systems and methods, and more particularly to audio systems and method for real time audio sound tuning.

Optimizing and tuning of audio systems such as, e.g., public address systems, can be complex and cumbersome. In particular, low frequency reflections off the floor can interfere with direct sound, causing comb-filtering and leading to inaccurate measurements during the tuning process.

### DESCRIPTION OF THE RELATED ART

There is a need for an audio system and method for real time audio sound tuning.

### SUMMARY

An audio system arranged in a listening environment includes a computing device including one or more processors and a memory, wherein the computing device is configured to execute an evaluation application, wherein executing the evaluation application comprises: output a reference audio signal to a loudspeaker for reproduction; evaluate a first microphone signal in order to determine a course of at least one parameter over a first frequency range, wherein the first microphone signal is captured by means of a first microphone in response to reproducing the reference audio signal by means of the loudspeaker, evaluate a second microphone signal in order to determine a course of at least one parameter over a first frequency range, wherein the second microphone signal is captured by means of a second microphone in response to reproducing the reference audio signal by means of the loudspeaker, blend the course of at least one of the at least one parameter determined for the first microphone with the course of the same at least one parameter determined for the second microphone, resulting in at least one blended course, and output the at least one blended course via a communication interface, wherein the first microphone is arranged at a first position within the listening environment, and between 0 am 0.1 meters vertically above a floor of the listening environment, and the second microphone is arranged at the first position within the listening environment, and between 1.1 and 1.9 meters vertically above the floor of the listening environment.

A method includes outputting a reference audio signal to a loudspeaker arranged in a listening environment for reproduction, evaluating a first microphone signal in order to determine a course of at least one parameter over a first frequency range, wherein the first microphone signal is captured by means of a first microphone arranged in the listening environment in response to reproducing the reference audio signal by means of the loudspeaker, evaluating a second microphone signal in order to determine a course of at least one parameter over a first frequency range, wherein the second microphone signal is captured by means of a second microphone in response to reproducing the reference audio signal by means of the loudspeaker, blending the course of at least one of the at least one parameter determined for the first microphone with the course of the same at least one parameter determined for the second microphone, resulting in at least one blended course, and outputting the at least one blended course via a communication interface, wherein the first microphone is arranged at a first position within the listening environment, and between 0 am 0.1 meters vertically above a floor of the listening environment, and the second microphone is arranged at the first position within the listening environment, and between 1.1 and 1.9 meters vertically above the floor of the listening environment.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 schematically illustrates an audio system according to one or more embodiments of the present disclosure;

FIG. 2 schematically illustrates an arrangement of different elements of the audio system of FIG. 1; and

FIG. 3 schematically illustrates, in a block diagram, an audio system according to one or more embodiments of the present disclosure.

FIG. 4 schematically illustrates magnitude responses of microphones included in the audio system according to one or more embodiments of the present disclosure.

FIG. 5 schematically illustrates phase responses of microphones included in the audio system according to one or more embodiments of the present disclosure.

FIG. 6 schematically illustrates a combined magnitude response according to one or more embodiments of the present disclosure.

FIG. 7 schematically illustrates a combined phase response according to one or more embodiments of the present disclosure.

FIG. 8 shows a flowchart illustrating a method according to one or more embodiments of the present disclosure.

### DETAILED DESCRIPTION

The following description relates to audio systems and related methods. The systems and methods herein disclosed are able to provide real time audio sound tuning. Low-frequency floor reflections often distort measurements performed on audio systems. For example, dealing with low-frequency flow reflections is often a challenge when tuning a Public Address, PA, audio system. PA audio systems are audio systems comprising microphones, loudspeakers, amplifiers and related equipment. PA audio systems are able to increase the apparent volume (loudness) of a human voice, musical instruments, or other acoustic sound sources or any kind of recorded sound or music. PA audio systems are often used in different kinds of public venues such as, e.g., sports stadiums, theaters, concert halls, public transportation vehicles and facilities, churches, auditoriums, bars, etc. A PA audio system usually comprises a plurality of microphones, one or more loudspeakers, and a mixing console for combining and/or modifying audio signals output via the one or more loudspeakers. The system is usually suitably adjusted based on measurements taken during a measurement or tuning process. Performing a measurement or tuning process can be complex and cumbersome. Low frequency reflections off the floor can interfere with direct sound, causing comb-filtering and leading to inaccurate measurements during the tuning process.

The systems and methods disclosed herein significantly simplify the measurement process. This is done by intelligently pairing microphones arranged in a listening environment and used to perform the measurements, and combining data captured by the respective microphones in real-time. In this way, accuracy of the measurements can be significantly increased, and extensive post-processing becomes superfluous. Even further, additional Digital Signal Processing, DSP, hardware is no longer required.

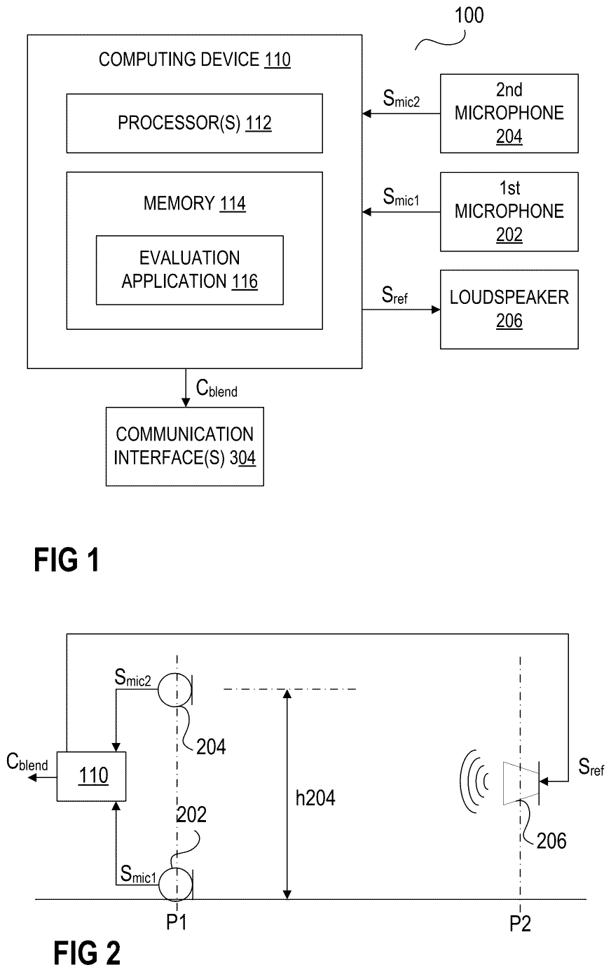

FIG. 1 schematically illustrates an audio system 100 in a block diagram. The audio system 100 comprises a computing device 110, the computing device 110 comprising one or more processors 112 and a memory 114. The computing device 110 is configured to execute evaluation application 116 stored in the memory 114, and perform a measurement process. Executing the evaluation application 116 comprises outputting a reference audio signal Sref to a loudspeaker 206 for reproduction. Executing the evaluation application 116 further comprises receiving and evaluating a first microphone signal Smic1 in order to determine a course of at least one parameter over a first frequency range Cmic1, the first microphone signal Smic1 being captured by means of a first microphone 202 in response to reproducing the reference audio signal by means of the loudspeaker 206. Executing the evaluation application 116 further comprises receiving and evaluating a second microphone signal Smic2 in order to determine a course of at least one parameter over a first frequency range Cmic2, wherein the second microphone signal Smic2 is captured by means of a second microphone 204 in response to reproducing the reference audio signal Sref by means of the loudspeaker 206. Executing the evaluation application 116 further comprises blending the course of at least one of the at least one parameter Cmic1 determined for the first microphone 202 with the course of the same at least one parameter Cmic2 determined for the second microphone 202, resulting in at least one blended course Cblend. The at least one blended course Cblend is then output via a communication interface 304. The reference audio signal Sref may be any kind of suitable reference signal such as, e.g., pink noise, a sweep, or anything similar.

Computing device 110 may be any kind of device that includes one or more processor(s) 112 such as a system-on-a-chip (SoC). Generally, computing device 110 may be configured to coordinate the overall operation of audio system 100. The embodiments disclosed herein contemplate any technically-feasible system configured to implement the functionality of audio system 100 via computing device 110.

Processor(s) 112 may be any technically-feasible form of processing device configured to process data and execute program code. Processor(s) 112 could include, for example and without limitation, a system-on-chip (SoC), a central processing unit (CPU), a graphics processing unit (GPU), an application specific integrated circuit (ASIC), a digital signal processor (DSP), a field programmable gate array (PFGA), and/or the like. Processor(s) 112 may include one or more processing cores. In operation, processor(s) 112 may be a primary processor of the computing device 110, controlling and coordinating operations of other system components. For example, processor(s) 112 may be configured to execute instructions (e.g., methods, algorithms, processes, etc.) stored in memory 114.

Memory 114 stores evaluation application 116, and may include a memory module or a collection of memory modules. Memory 114 may be non-transitory memory or other form of non-volatile memory, random access memory (RAM), or any other feasible type of memory storage system. In various embodiments, processor(s) 112 can execute evaluation application 116 to perform a measurement and tuning process to implement the overall functionality of the computing device 110 and, thus, to coordinate the operation of the audio system 100 as a whole. In some embodiments, evaluation application 116 may be stored and loaded into the memory 114 for execution.

As schematically illustrated in FIG. 2, the first microphone 202 is arranged at a first position P1 within a listening environment. The first microphone 202 is arranged at floor level, that is it is arranged and between 0 am 0.1 meters vertically above a floor of the listening environment. The second microphone 204 is also arranged at the first position P1 within the listening environment. The second microphone 204, however, is arranged at a level above the floor of the listening environment (height h204) which corresponds to the level of a head of a typical user. That is, the second microphone 204 is arranged between 1.1 and 1.9 meters vertically above the floor of the listening environment. An average person generally is between about 1.6 and 1.9 meters tall. When seated, e.g., on a chair, the height of a person's head above the floor level is generally lower, e.g., between 1.1 and 1.55 meters. The loudspeaker 206 is arranged at a second position P2 within the listening environment which differs from the first position P1. The loudspeaker 206 may be arranged at floor level, at head level, anywhere between floor and head level, or even above head level. The listening environment may be any kind of small, medium, or large sized listening environment such as, e.g., a sports stadium, a theater, a concert hall, a public transportation vehicle or facility, a church, an auditorium, a bar, etc.

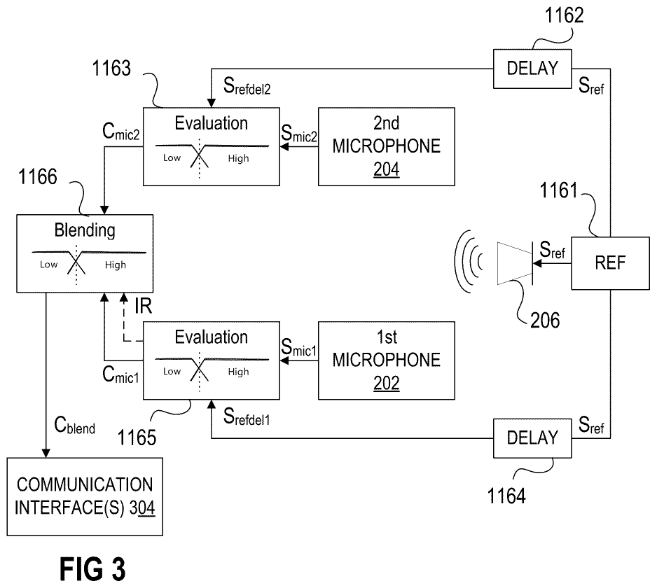

Now referring to FIG. 3, evaluating the first microphone signal Smic1 may comprise comparing the first microphone signal Smic1 to a first delayed version Srefdel1 of the reference audio signal Sref. Similarly, evaluating the second microphone signal Smic1 may comprise comparing the second microphone signal Smic1 to a second delayed version Srefdel2 of the reference audio signal Sref. The reference audio signal Sref may be delayed to generate the first delayed version Srefdel1 by means of a first delay unit 1164, and the reference audio signal Sref may be delayed to generate the second delayed version Srefdel2 by means of a second delay unit 1162. The delay applied may be the same for generating the first delayed version Srefdel1 and the second delayed version Srefdel2 of the reference audio signal Sref. This may be the case, for example, if a distance between the loudspeaker 206 and the first microphone 202 equals a distance between the loudspeaker 206 and the second microphone 204. If a distance between the loudspeaker 206 and the first microphone 202 is longer or shorter than a distance between the loudspeaker 206 and the second microphone 204, the delay applied may be different for generating the first delayed version Srefdel1 and the second delayed version Srefdel2 of the reference audio signal Sref. The reference audio signal Sref may be delayed appropriately, as the reference audio signal Sref output via the loudspeaker 206 generally requires a certain amount of time to reach the first and second microphones 202, 204, respectively. This time depends on the distance the reference audio signal Sref has to travel. According to some embodiments, the delay applied to the reference audio signal Sref may be equal to a sum of a latency of the measurement system (e.g., microphone and components required for signal evaluation), a latency of the reproduction system (e.g., loudspeaker and components required for signal reproduction), and a distance between the loudspeaker 206 and the respective microphone 202, 204.

Still referring to FIG. 3, the audio system may comprise a first evaluation unit 1165 configured to evaluate the first microphone signal Smic1 in order to determine a course of at least one parameter over a first frequency range. The audio system may further comprise a second evaluation unit 1163 configured to evaluate the second microphone signal Smic2 in order to determine a course of at least one parameter over a first frequency range. Instead of two separate evaluation units 1163, 1165 as illustrated in FIG. 3, it is however also possible that both evaluations be performed by means of the same evaluation unit. The audio system may further comprise a blending unit 1166 configured to blend the course of at least one of the at least one parameter Cmic1 determined for the first microphone 202 with the course of the same at least one parameter Cmic2 determined for the second microphone 202, resulting in at least one blended course Cblend. The reference audio signal Sref may be output by means of a reference signal generation unit 1161, for example.

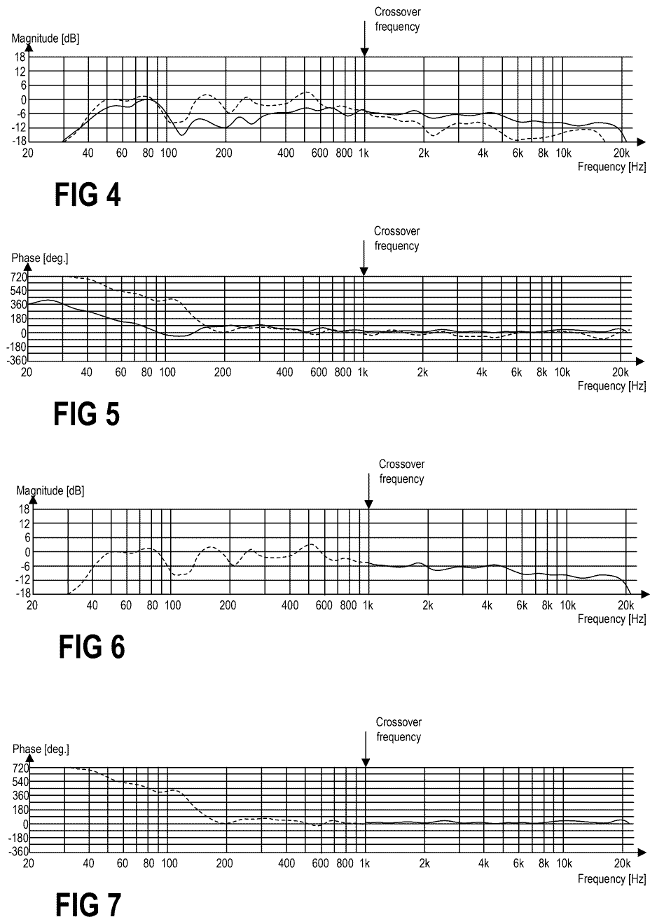

The at least one parameter may comprise at least one of a magnitude, a phase, and a coherence. That is, for example, a magnitude response and/or a phase response may be determined for each of the first and second microphones 202. FIG. 4 schematically illustrates exemplary magnitude responses of a first and a second microphone 202, 204 included in an audio system according to one or more embodiments of the present disclosure. In FIG. 4, the dashed line illustrates the magnitude response of the first microphone 202, and the continuous line illustrates the magnitude response of the second microphone 204.

FIG. 5 schematically illustrates exemplary phase responses of a first and a second microphone 202, 204 included in an audio system according to one or more embodiments of the present disclosure. In FIG. 5, the dashed line illustrates the phase response of the first microphone 202, and the continuous line illustrates the phase response of the second microphone 204.

According to some embodiments, blending the course of at least one of the at least one parameter determined for the first microphone 202 with the course of the same at least one parameter determined for the second microphone 202 comprises at least one of merging the course of a magnitude response determined for the first microphone 202 and related to frequencies below a defined crossover frequency with the course of a magnitude response determined for the second microphone 204 and related to frequencies above the defined crossover frequency, and merging the course of a phase response determined for the first microphone 202 and related to frequencies below a defined crossover frequency with the course of a phase response determined for the second microphone 204 and related to frequencies above the defined crossover frequency. This method will be referred to in the following as blending method 1.

This is schematically illustrated in FIG. 6 for the magnitude response, and in FIG. 7 for the phase response. As can be seen, below a defined crossover frequency, the course of the respective parameter (magnitude/phase) of the first microphone 202 arranged at floor level is chosen, and above the defined crossover frequency, the course of the respective parameter (magnitude/phase) of the second microphone 204 arranged at head level is chosen. That is, FIG. 6 illustrates a blended course Cblend of the magnitude response, and FIG. 7 illustrates a blended course Cblend of the phase response. What is shown in FIGS. 4 to 7 similarly applies to a coherence, for example. The Crossover frequency may be suitable chosen in order to achieve ideal results. The first frequency range may cover frequencies between 20 Hz and 20 KHz, for example, as is schematically illustrated in FIGS. 4 to 7. This is the frequency range typically covered by conventional microphones. According to some embodiments, the crossover frequency may be between 900 Hz and 1100 Hz. For example, the crossover frequency may be set to 1000 Hz, which divides the spectrum (first frequency range) into two (almost) equal parts in terms of auditory experience (log), as can be seen in the figures.

That is, the following may apply for each frequency band b (or for each frequency b) within the first frequency range:

$${use\_floor}_{b} = \{ \begin{matrix}1 , if b \leq crossover\_band \\ 0 , if b > crossover\_band\end{matrix}$$

$${result\_magnitude}_{b} = {use\_floor}_{b} \times {floor\_magnitude}_{b} + ( 1 - {use\_floor}_{b} ) \times {head\_magnitude}_{b}$$

$${result\_phase}_{b} = {use\_floor}_{b} \times {floor\_phase}_{b} + ( 1 - {use\_floor}_{b} ) \times {head\_phase}_{b}$$

$${result\_coherence}_{b} = {use\_floor}_{b} \times {floor\_coherence}_{b} + ( 1 - {use\_floor}_{b} ) \times {head\_coherence}_{b}$$

The first microphone 202 arranged at floor level generally captures low-frequency data with minimal floor reflection interference. Therefore, combining low frequency results from the first microphone 202 with mid- and high-frequency results from the second microphone 204, provides optimal measurement results. The combined magnitude and/or phase responses as illustrated in FIGS. 6 and 7, for example, may be output via communication interface 304.

However, combining low-frequency results (below crossover frequency) of the first microphone 202 with mid- and high-frequency results (above crossover frequency) from the second microphones 204 is only an example. According to further embodiments of the disclosure, blending the course of at least one of the at least one parameter determined for the first microphone 202 with the course of the same at least one parameter determined for the second microphone 202 may comprise, for each of a plurality of frequency bands b within the first frequency range, determine a first coherence between a first parameter of the first microphone signal Smic1 and the respective first parameter of the delayed version of the reference audio signal Srefdel1, for each of the plurality of frequency bands b within the first frequency range, determine a second coherence between the first parameter of the second microphone signal Smic2 and the respective first parameter of the delayed version of the reference audio signal Srefdel2, for each of the plurality of frequency bands b within the first frequency range, compare the respective first coherence to the respective second coherence in order to determine which coherence is higher, and generate the blended course Cblend by choosing for each of the plurality of frequency bands b the respective first parameter for which the coherence has been determined to be higher. This method will be referred to in the following as blending method 2.

That is, the following may apply for each frequency band b (or for each frequency b) within the first frequency range:

$${use\_floor}_{b} = \{ \begin{matrix}1 , if b \leq crossover\_band \\ 0 , if b > crossover\_band\end{matrix}$$

$${result\_magnitude}_{b} = {use\_floor}_{b} \times {floor\_magnitude}_{b} + ( 1 - {use\_floor}_{b} ) \times {head\_magnitude}_{b}$$

$${result\_phase}_{b} = {use\_floor}_{b} \times {floor\_phase}_{b} + ( 1 - {use\_floor}_{b} ) \times {head\_phase}_{b}$$

$${result\_coherence}_{b} = {use\_floor}_{b} \times {floor\_coherence}_{b} + ( 1 - {use\_floor}_{b} ) \times {head\_coherence}_{b}$$

In other words, data used for the blended course Cblend may be chosen based on coherence. For each band b (or frequency b) within the first frequency range, data acquired by means of the first microphone 202 (floor level) may be chosen if the first microphone 202 has a higher coherence than the second microphone 204 (head level) for the respective band b (frequency b). Data acquired by means of the second microphone 204 (head level) may be chosen if the second microphone 204 has a higher coherence than the first microphone 202 (floor level) for the respective band b (frequency b).

According to even further embodiments of the disclosure, blending the course of at least one of the at least one parameter determined for the first microphone 202 with the course of the same at least one parameter determined for the second microphone 202 may comprise, for each of a plurality of frequency bands b within the first frequency range, determine a first coherence between a first parameter of the first microphone signal Smic1 and the respective first parameter of the delayed version of the reference audio signal Srefdel1, for each of the plurality of frequency bands b within the first frequency range, determine a second coherence between the first parameter of the second microphone signal Smic2 and the respective first parameter of the delayed version of the reference audio signal Srefdel1, for each of the plurality of frequency bands b, add the first coherence to the second coherence, to generate a weighting factor, and, for each of the plurality of frequency bands b, generate the blended course Cblend by multiplying the respective first parameter of the first microphone signal Smic1 with the respective first coherence, resulting in a first value, multiplying the respective first parameter of the second microphone signal Smic2 with the respective second coherence, resulting in a second value, adding the first value to the second value, resulting in a third value, and dividing the third value by the weighting factor. This method will be referred to in the following as blending method 3.

That is, the following may apply for each frequency band b (or for each frequency b) within the first frequency range:

$${factor}_{b} = {floor\_coherence}_{b} \times {head\_coherence}_{b}$$

$${result}_{m a g n i t u t e} = \frac{\begin{matrix}{floor\_magnitude}_{b} \times {floor\_coherence}_{b} + \\ {head\_magnitude}_{b} \times {head\_coherence}_{b}\end{matrix}}{{factor}_{b}}$$

$${result}_{p h a s e} = \frac{\begin{matrix}{floor\_phase}_{b} \times {floor\_coherence}_{b} + \\ {head\_phase}_{b} \times {head\_coherence}_{b}\end{matrix}}{{factor}_{b}}$$

$${result}_{c o h e r e n c e} = \frac{{floor\_coherence}_{b} + {head\_coherence}_{b}}{2}$$

In other words, a weighted average of data acquired by means of the first microphone 202 (floor level) and data acquired by means of the second microphone 204 (head level) may be calculated for each band b (or frequency b) within the first frequency range, with coherence values used as the weighting factor.

Each frequency band b of the plurality of frequency bands may cover a single frequency or a plurality of adjacent frequencies. For example, each frequency band b may have a defined width, thereby covering a defined number of frequencies.

It is generally possible to implement different methods for different values. That is, for example, blending method 3 may be used for magnitude, and blending method 2 may be used for phase and coherence. Different combinations of the different methods for different parameters are naturally also possible.

In addition to determining transfer functions (magnitude/phase) and coherence, as described above, it is generally also possible to determine impulse responses, IR, of the first microphone 202, and the second microphone 204. According to some embodiments, the impulse responses, however, are not blended. Instead, the impulse response determined for the second microphone 204 (head level) may be output via the communication interface 304, for example, similar to what is schematically illustrated in FIG. 3.

The communication interface 304 may be coupled to any kind of user interface, for example. According to some embodiments, the communication interface 304 may be coupled to a display. That is, the automatically generated blended course Cblend may be presented to a user of the audio system on a display for further evaluation. Based on the measurement results presented on the display, a user may manually tune the audio system. It is, however, also possible that the audio system be automatically tuned based on the results. That is, alternatively or additionally, the communication interface 304 may be coupled to any kind of tuning system which is able to automatically evaluate the measurement results and automatically tune the audio system based on the measurement results.

The first microphone 202 and the second microphone 204 of the audio systems described above are arranged at the same position P1 within the listening environment (one at floor level, the other one at head level) and form a pair of microphones. For small listening environments, performing measurements using a single pair of microphones may be sufficient. However, for medium and large sized listening environments, two or more pairs of microphones may be arranged at different positions within the respective listening environment. What has been described above with respect to one pair of microphones similarly applies for each pair of microphones of a plurality of pairs of microphones arranged in a listening environment. Measurements for a plurality of pairs of microphones may be performed simultaneously. That is, one audio signal may be output by the loudspeaker 206, which is captured by each microphone of the plurality of pairs of microphones. The audio system and methods according to the embodiments described herein allow performing of measurements in real-time. Different parameters of the audio system such as, e.g., alignment delays, microphone gains, and calibrations, can be adjusted, e.g., by a user of the audio system between different measurements. For example, alignment delays may be adjusted in order to accurately synchronize the first and second microphones 202, 204. Microphone gains may be modified to account for differences in sensitivity. Microphone calibrations may be applied to ensure that an accurate frequency response is determined.

The first microphone 202 and the second microphone 204 may be coupled to the audio system 100 by means of a wired or by means of a wireless connection. When using a wireless connection, setup time of the overall system may be reduced. Even further, the overall system is more flexible and mobility is increased when using a wireless connection.

The audio system 100 may be used for sound tuning at live events, for example, such as concerts, festivals, and theater productions, where sound quality is paramount. The audio system 100 may also be used for permanent installations such as, e.g., churches, conference centers, and educational institutions which require consistent audio performance. The audio system 100 may further be used for recording studios to fine-tune studio monitors for accurate sound reproduction, for example. Even further, the audio system 100 may be used for performing acoustic research, e.g., for academic or professional research concerning room acoustics and sound system behavior. The audio systems 100 according to the different embodiments described herein may also be used for any other kind of application.

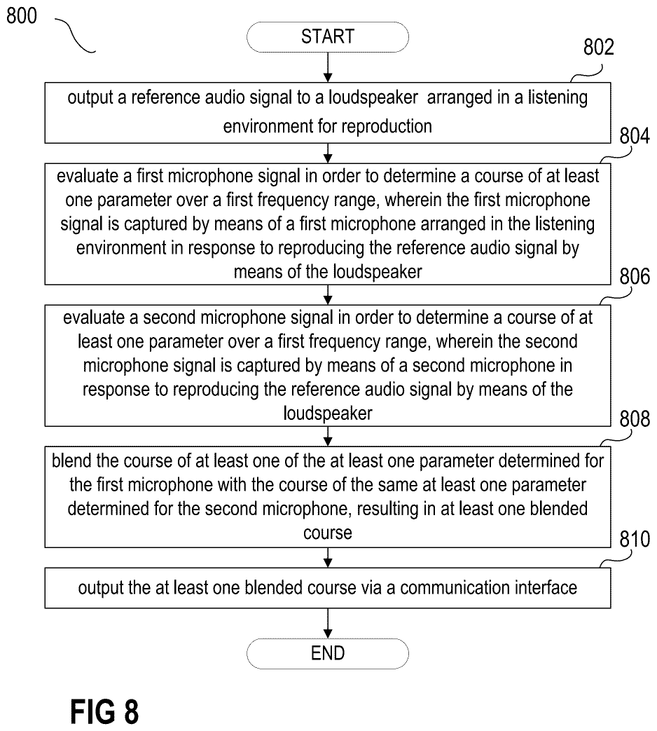

Now referring to FIG. 8, a method according to embodiments of the disclosure is schematically illustrated in a flowchart. The method 800 comprises outputting a reference audio signal to a loudspeaker 206 arranged in a listening environment for reproduction (step 802). The method further comprises evaluating a first microphone signal in order to determine a course of at least one parameter over a first frequency range, wherein the first microphone signal is captured by means of a first microphone 202 arranged in the listening environment in response to reproducing the reference audio signal by means of the loudspeaker 206 (step 804), and evaluating a second microphone signal in order to determine a course of at least one parameter over a first frequency range, wherein the second microphone signal is captured by means of a second microphone 204 in response to reproducing the reference audio signal by means of the loudspeaker 206 (step 806). The method further comprises blending the course of at least one of the at least one parameter determined for the first microphone 202 with the course of the same at least one parameter determined for the second microphone 202, resulting in at least one blended course (step 808), and outputting the at least one blended course via a communication interface 304 (step 810). As has been described above, the first microphone 202 is arranged at a first position P1 within the listening environment, and between 0 am 0.1 meters vertically above a floor of the listening environment, and the second microphone 204 is arranged at the first position P1 within the listening environment, and between 1.1 and 1.9 meters vertically above the floor of the listening environment.

The audio systems and methods according to the various embodiments described herein provide significant enhancement in audio tuning by simplifying the process of mitigating low-frequency floor reflections. By intelligently pairing a microphone arranged at floor level, and a microphone arranged at the same position at head level, and blending their respective measurement results in real-time, and by further providing extensive offline post-processing capabilities, the audio systems and methods according to the various embodiments disclosed herein provide a practical and efficient solution which enhances measurement accuracy without the need for complex post-processing or additional hardware.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. An audio system arranged in a listening environment, the audio system comprising:
a computing device comprising one or more processors and a memory, wherein the computing device is configured to execute an evaluation application, wherein the evaluation application causes the computing device to perform the steps of:
outputting a reference audio signal to a loudspeaker for reproduction;
evaluating a first microphone signal to determine a first course of at least one parameter over a first frequency range, wherein the first microphone signal is captured by a first microphone in response to reproducing the reference audio signal by the loudspeaker;
evaluating a second microphone signal to determine a second course of the at least one parameter over the first frequency range, wherein the second microphone signal is captured by a second microphone in response to reproducing the reference audio signal by the loudspeaker;
blending the first course with the second course to generate at least one blended course; and
outputting the at least one blended course via a communication interface, wherein the first microphone is arranged at a first position within the listening environment and the second microphone is arranged at second position within the listening environment vertically above the first position.

2. The audio system of claim 1, wherein the first position is between 0 and 0.1 meters vertically above a floor of the listening environment, and the second position is between 1.1 and 1.9 meters vertically above the floor of the listening environment.

3. The audio system of claim 1, wherein evaluating the first microphone signal comprises:
comparing the first microphone signal to a delayed version of the reference audio signal; and
evaluating the second microphone signal comprises comparing the second microphone signal to the delayed version of the reference audio signal.

4. The audio system of claim 3, wherein the at least one parameter comprises at least one of a magnitude, a phase, or a coherence.

5. The audio system of claim 1, wherein blending the first course with the second course comprises at least one of:
merging a third course of a magnitude response determined for the first microphone and related to frequencies below a defined crossover frequency with a fourth course of a magnitude response determined for the second microphone and related to frequencies above the defined crossover frequency, or
merging a fifth course of a phase response determined for the first microphone and related to frequencies below a defined crossover frequency with a sixth course of a phase response determined for the second microphone and related to frequencies above the defined crossover frequency.

6. The audio system of claim 5, wherein the crossover frequency is between 900 Hz and 1100 Hz.

7. The audio system of claim 1, wherein blending the first course with the second course comprises:
for each of a plurality of frequency bands within the first frequency range, determine a first coherence between a first parameter of the first microphone signal and a respective first parameter of a delayed version of the reference audio signal;
for each of the plurality of frequency bands within the first frequency range, determine a second coherence between the first parameter of the second microphone signal and the respective first parameter of the delayed version of the reference audio signal;
for each of the plurality of frequency bands within the first frequency range, compare the respective first coherence to the respective second coherence to determine which coherence is higher; and
generating the blended course by selecting, for each of the plurality of frequency bands, the respective first parameter for which the coherence is higher.

8. The audio system of claim 1, wherein blending the first course with the second course comprises:
for each of a plurality of frequency bands within the first frequency range, determine a first coherence between a first parameter of the first microphone signal and the respective first parameter of a delayed version of the reference audio signal,
for each of the plurality of frequency bands within the first frequency range, determine a second coherence between the first parameter of the second microphone signal and the respective first parameter of the delayed version of the reference audio signal,
for each of the plurality of frequency bands, add the first coherence to the second coherence to generate a weighting factor, and
for each of the plurality of frequency bands, generating the blended course by multiplying the respective first parameter of the first microphone signal with the respective first coherence, resulting in a first value, multiplying the respective first parameter of the second microphone signal with the respective second coherence, resulting in a second value, adding the first value to the second value, resulting in a third value, and dividing the third value by the weighting factor.

9. The audio system of claim 1, wherein the first frequency range covers frequencies between 20 Hz and 20 KHz.

10. The audio system of claim 1, wherein the reference audio signal is pink noise, or a sweep.

11. A method, comprising:
outputting a reference audio signal to a loudspeaker for reproduction;
evaluating a first microphone signal to determine a first course of at least one parameter over a first frequency range, wherein the first microphone signal is captured by a first microphone in response to reproducing the reference audio signal by the loudspeaker;
evaluating a second microphone signal to determine a second course of the at least one parameter over the first frequency range, wherein the second microphone signal is captured by a second microphone in response to reproducing the reference audio signal by the loudspeaker;
blending the first course with the second course to generate at least one blended course; and
outputting the at least one blended course via a communication interface, wherein the first microphone is arranged at a first position within a listening environment and the second microphone is arranged at second position within the listening environment vertically above the first position.

12. The method of claim 11, wherein the first position is between 0 and 0.1 meters vertically above a floor of the listening environment, and the second position is between 1.1 and 1.9 meters vertically above the floor of the listening environment.

13. The method of claim 11, wherein evaluating the first microphone signal comprises:
comparing the first microphone signal to a delayed version of the reference audio signal; and
evaluating the second microphone signal comprises comparing the second microphone signal to the delayed version of the reference audio signal.

14. The method of claim 13, wherein the at least one parameter comprises at least one of a magnitude, a phase, or a coherence.

15. The method of claim 11, wherein blending the first course with the second course comprises at least one of:
merging a third course of a magnitude response determined for the first microphone and related to frequencies below a defined crossover frequency with a fourth course of a magnitude response determined for the second microphone and related to frequencies above the defined crossover frequency, or
merging a fifth course of a phase response determined for the first microphone and related to frequencies below a defined crossover frequency with a sixth course of a phase response determined for the second microphone and related to frequencies above the defined crossover frequency.

16. The method of claim 15, wherein the crossover frequency is between 900 Hz and 1100 Hz.

17. The method of claim 11, wherein blending the first course with the second course comprises:
for each of a plurality of frequency bands within the first frequency range, determine a first coherence between a first parameter of the first microphone signal and a respective first parameter of a delayed version of the reference audio signal;
for each of the plurality of frequency bands within the first frequency range, determine a second coherence between the first parameter of the second microphone signal and the respective first parameter of the delayed version of the reference audio signal;
for each of the plurality of frequency bands within the first frequency range, compare the respective first coherence to the respective second coherence to determine which coherence is higher; and
generating the blended course by selecting, for each of the plurality of frequency bands, the respective first parameter for which the coherence is higher.

18. The method of claim 11, wherein blending the first course with the second course comprises:
for each of a plurality of frequency bands within the first frequency range, determine a first coherence between a first parameter of the first microphone signal and the respective first parameter of a delayed version of the reference audio signal,
for each of the plurality of frequency bands within the first frequency range, determine a second coherence between the first parameter of the second microphone signal and the respective first parameter of the delayed version of the reference audio signal,
for each of the plurality of frequency bands, add the first coherence to the second coherence to generate a weighting factor, and
for each of the plurality of frequency bands, generating the blended course by multiplying the respective first parameter of the first microphone signal with the respective first coherence, resulting in a first value, multiplying the respective first parameter of the second microphone signal with the respective second coherence, resulting in a second value, adding the first value to the second value, resulting in a third value, and dividing the third value by the weighting factor.

19. The method of claim 11, wherein the first frequency range covers frequencies between 20 Hz and 20 kHz.

20. One or more non-transitory computer-readable media storing instructions that, when executed by one or more processors, cause the one or more processors to perform a method comprising:
outputting a reference audio signal to a loudspeaker for reproduction;
evaluating a first microphone signal to determine a first course of at least one parameter over a first frequency range, wherein the first microphone signal is captured by a first microphone in response to reproducing the reference audio signal by the loudspeaker;
evaluating a second microphone signal to determine a second course of the at least one parameter over the first frequency range, wherein the second microphone signal is captured by a second microphone in response to reproducing the reference audio signal by the loudspeaker;
blending the first course with the second course to generate at least one blended course; and
outputting the at least one blended course via a communication interface, wherein the first microphone is arranged at a first position within a listening environment and the second microphone is arranged at second position within the listening environment vertically above the first position.
